(19) United States
(12) Patent Application Publication
(10) Pub. No.: US 2003/0070118 A1
(43) Pub. Date: Apr. 10, 2003

(54) Semiconductor integrated circuit with built-in test function

(75) Inventors: Michinobu Nakao, Hachioji (JP); Kazumi Hatayama, Hachioji (JP)

Correspondence Address: Stanley P. Fisher, Reed Smith LLP, Suite 1400, 3110 Fairview Park Drive, Falls Church, VA, 22042-4503, US

(73) Assignee: Hitachi, Ltd.

(21) Appl. No.: 10/173,001

(22) Filed: Jun. 18, 2002

(30) Foreign Application Priority Data
Oct. 9, 2001 (JP) 2001-311739

(51) Int. Cl. H04L 1/22

(52) U.S. Cl. 714/30

(57) ABSTRACT

An execution time of a built-in test utilizing a decoder can be shortened by setting in parallel the codes of test pattern generator during execution of a self-test in order to eliminate an event that a test execution time increases due to increase of the time required for setting the test codes when the number of test codes increases. Namely a semiconductor integrated circuit with a built-in test (BIT) function is provided with a test code backup register for storing the codes of a test pattern generator, a test clock generator and a BIT controller to realize a function to set the codes required for execution of the next self-test in parallel to execution of the self-test and a function to immediately shift to the next self-test upon completion of the first self-test execution. A tester periodically observes a self-test end signal BEND during execution of a self-test and immediately applies the next code to the semiconductor integrated circuit when it observes a signal indicating the end of the self-test. Thereby, the test execution time can be reduced in the built-in test utilizing the decoder because the time required for setting of codes for each unit self-test can be reduced almost to zero.

### FIELD OF THE INVENTION

The present invention relates to a semiconductor integrated circuit with a built-in test function, a storage medium for storing electronic design data comprising a test-code generation program, a method of testing semiconductor integrated circuit, a method of automatically generating test code and a program thereof.

### BACKGROUND OF THE INVENTION

A BIST(Built-In Self-Test) is one of the test methods for inspecting a manufacturing fault of a semiconductor integrated circuit (LSI). The BIST system is intended for the reduction in amount of test data to be stored in a tester, the reduction in the number of test-access pins and the reduction of a test execution time. The BIST system comprises a pattern generator and a test response compactor. A test pattern generated by a test pattern generator is given to a circuit under test, the test response pattern is repeatedly compressed for the test response compactor and a result of the test response compactor is compared with an expectancy value.

For example, as described in the U.S. Pat. No. 4,503,537 “Parallel Path Self-Testing System”, a linear-feedback shift-register (LFSR) is generally used as a test pattern generator and a multiple-input signature-register (MISR) is used as a test response compactor.

However, since a test pattern generated by LFSR is formed of a pseudo-random pattern, a high fault coverage cannot be obtained from the limited number of patterns. As a method of improving the fault coverage in the BIST system, there is provided a test method in which a data obtained by coding a test pattern is previously stored in a tester and loading of the data and generation of test pattern by the decoding are repeated.

The data obtained by coding the test pattern is called a test-code and a self-test during generation of test pattern by the decoding is only called a unit self-test. Since the loading of the test code is necessary before each unit self-test, this test method is called the BIT (Built-In Test) for discrimination from the BIST system. The typical method is the reseeding technique described in the paper entitled as “Generation of vector patterns through reseeding of multiple-polynomial linear feedback shift registers” written by Hellebrand on pages 120 to 129 of the reference “Proceeding of International Test Conference 92 (1992)”. The initial condition of LFSR called the seed is calculated from the test pattern to be generated and this seed is replaced sequentially during execution of test.

A practical problem in regard to a test execution time rises here for application of the BIT system represented by the reseeding technique to the test of LSI.

First, a test method in the first case where a clock signal during execution of unit self-test and an internal control signal for controlling operations of the test pattern generator, circuit under test and test response compactor are supplied from the tester will be explained with reference to FIG. 10 and FIG. 11.

FIG. 10 is a flow diagram of the existing test method in the BIT system. Flow of an automatic test equipment (ATE) and the flow of a semiconductor integrated circuit (LSI) are illustrated in parallel. First, the ATE applies, in the step 1001, a sequence of test-code loaded from a local memory to the LSI and this LSI loads, in the step 1021, the test-code. Upon completion of load of the test-code, the ATE switches, in the step 1002, the pattern generation method to the pattern generation utilizing the ALPG function from the load from a local memory. During this period, the LSI is in the waiting condition.

Next, the ATE controls, in the step 1003, a signal so that the LSI executes the unit self-test based on the ALPG function. Therefore, the LSI executes the unit self-test in the step 1023 depending on such signal. The ATE switches, in the step 1004, the pattern generation method to the load from local memory from use of the ALPG function. During this period, the LSI is also in the waiting condition. The ATE returns to the step 1001 when there are test codes not loaded in the step 1005 and the LSI also returns to the step 1021 from the step 1025. When the ATE has judged in the step 1005 that all test-codes are loaded, it goes to the step 1006 to control the signal to read the condition of the test response compactor having compressed the test response pattern onto the local memory. In this case, the LSI outputs, depending on this control, the condition of the test response compactor in the step 1026.

As will be understood from the above flow diagrams, in the test method explained above, for the single unit self-test, two times of switching operations of the test pattern generation method of ATE are required. Namely, switching to use of ALPG from use of the local memory and the inverse switching thereof are required. Moreover, since the unit self-test of about 100 to 10000 times is required in the BIT system to obtain the higher fault coverage, the number of times of the switching in the test pattern generation method of ATE is increased up to the two times the number of unit self-tests. After all, the time required for switching of the ATE test pattern generation method occupies the greater part of the test execution time.

Meanwhile, only the local memory of ATE is used in the existing scan test method, while the unit self-test is used only once in the BIST system described first in the prior art. Therefore, the switching of the test pattern generation method is conducted only twice at the beginning and the ending times of test. Accordingly, a problem in which the test time increases due to the switching of the ATE test pattern generation method can be said as only a peculiar problem of the BIT system.

As the reference, an example of timing chart of the existing test method in the BIT system is illustrated in FIG. 11. In this example, it is assumed as the pre-condition that the number of registers for indicating the conditions of the test pattern generator and test response compactor is set to three, the maximum length of scan chain is set to four and the number of patterns to be tested in the unit self-test is set to three. Moreover, the ATE test pattern generation method switching time is set to 100 times the time of the ALPG test pattern generation cycle. The Time line indicates time, while the ATE line indicates discrimination of use of local memory (Loc_Mem) and use of ALPG (ALPG). In this figure, a signal (BCNTL) for controlling the execution mode of the load/read and unit self-test in the BIT system, a signal (TD1) for inputting the test codes, a signal (TD0) for outputting a compression response pattern, a clock signal (CK) and a scan enable signal (SEN) are illustrated.

During the times 1 to 221, an operation in regard to the first execution of the unit self-test is conducted. During the times 1 to 6, the initial condition value of the test pattern generator is set in serial by loading the test code (C11, C12, C13) used for the unit self-test from the signal TDI. During the times 7 to 106, the ATE pattern generation method is switched to use of ALPG from use of local memory. During the times 107 to 122, the first unit self-test is executed. Since the scan enable signal SEN is controlled, the pattern setting due to the scan shift operation of four cycles of clock signal CK and the test response pattern fetch operation due to the normal operation of the circuit under test of single cycle are repeated for three times. The test response pattern fetched by a scan flip-flop is compressed as the condition of the test response compactor during the scan shift operation corresponding to the next four cycles.

For example, the first pattern is set at the times 107 to 110 and a response pattern of the test for the first pattern, namely of the circuit under test is fetched at the time 111, and such test response pattern is compressed at the times 112 to 115. At the times 112 to 115, the second pattern is also set simultaneously. As explained above, the second pattern is tested at the time 116, while the third pattern is tested at the time 121. A test response pattern for the third pattern is compressed within the four cycles of the clock CK supplied to the circuit under test after the time 223. During the times from 122 to 221, the ATE test pattern generation method is switched to use of local memory from use of ALPG. During the times from 222 to 447, the operation in regard to execution of the second unit self-test is conducted in the same manner as the first unit self-test. During the times from 448 to 454, the state (R1, R2, R3) of the test response compactor is read from the signal TD0. In above example, the time required for the ATE test pattern method switching is 400 among the test execution time of 454.

Next, the second case is considered as the method which is used in general in the BIST system, where the method for generating a scan enable signal within the LSI using a counter is also used in common in the BIT system. In this case, only the local memory storing test data can be used without utilization of the ALPG function of the tester. However, a problem that the number of test data increases is generated when the data of clock signal is stored as the test data. Moreover, when a free-running pulse generated within the LSI is used as the clock signal, switching of the clock signal is required at the beginning and the ending times of execution of the unit self-test because the clock signal for loading the test-code is supplied from the tester. Since the switching of clock signal is executed frequently in the BIT system, there rises a problem that the test execution time in the BIT system is extended if the clock signal is not switched within a short period of time.

Considering the problems explained above, it is an object of the present invention to shorten the test execution time without any increase in amount of test data by providing a semiconductor integrated circuit with a built-in test function and a storage medium for storing electronic design data consisting of a test-code generation program and utilizing a semiconductor integrated circuit test method, an automatic test code generating method and a program thereof.

### SUMMARY OF THE INVENTION

In order to attain the object explained above, the present invention provides a semiconductor integrated circuit with built-in test function, comprising a test-code register for storing test codes of a plurality of unit self-tests of which operations are regulated with test-codes given from external circuits, a first clock signal used for setting the test-codes to the register, a second clock signal used for unit self-test operation, an ending signal for indicating whether the unit self-test has been ended or not and a built-in test controller for generating the signals required for the circuit under test and the ending signal by inputting the first and second clock signals, which automatically stops supply of the second clock signal to the circuit under test when the unit self-test is completed and also sets a signal value indicating the end of unit self-test to the ending signal when the unit self-test ends.

Moreover, the present invention also provides a semiconductor integrated circuit with built-in test function, also comprising a test code register for storing test codes of a plurality of unit self-tests of which operations are regulated with the test codes given from an external circuit and a test-code backup register for storing all test-codes or a part of test-codes, whereby the test-codes of the test-code register are reviewed or updated during execution of the unit self-test and the test-code of the new unit self-test to be executed continuously is set to the test-code backup register with the tester.

Moreover, the present invention also provides a semiconductor integrated circuit test method for including a plurality of menus of unit self-tests of which operation is regulated with a test-code given from an external circuit of the semiconductor integrated circuit, the method comprising the steps of:

a first step for setting a test-code to a test-code register provided within a test pattern generator, by using a first clock signal supplied from a tester;

a second step for performing one of the unit self-tests of the circuit under test by using a second clock signal generated in the semiconductor integrated circuit;

a third step for performing a monitoring of a unit self-test end signal indicating the end of the predetermined unit self-test by the tester; and

a fourth step for returning to the first step until the menu of a plurality of the unit self-tests ends.

Moreover, the present invention also provides a semiconductor integrated circuit test method including a plurality of menus of the unit self-test of which operations are regulated with the test code given from an external circuit of the semiconductor integrated circuit, comprising a first step for setting the test-code to the test-code backup register using the first clock signal supplied by the tester; a second step for copying the data of the test-code backup register to the test-code register; a third step for executing the unit self-test of the circuit under test with using the second clock signal generated therein and setting the new test code to be executed continuously to the test code backup register using the first clock signal supplied from the tester; a fourth step for observing the unit self-test end signal indicating the end of the unit self-test by the tester; and a fifth step for returning to the second step until a plurality of unit self-tests are ended.

Moreover, the present invention also provides a semiconductor integrated circuit test method with built-in test function including a plurality of menus of the unit self-test of which operations are regulated with the test code given from an external circuit of the semiconductor integrated circuit, wherein the test code is given from an external tester, the test code includes an information about the number of test patterns corresponding to a plurality of unit self-tests and the number of test patterns is changed for every execution of the unit self-test.

Moreover, the present invention provides a semiconductor integrated circuit test method with a built-in function including a plurality of menus of unit self-test of which operations are regulated with the test-code given from an external circuit of the semiconductor integrated circuit, wherein a test board for connecting the tester and semiconductor integrated circuit comprises a counter for counting up the number of test patterns tested in the circuit under test, generates a test control signal required for the unit self-test and applies the test control signal to the circuit under test in the semiconductor integrated circuit.

Moreover, the present invention provides a test-code generation program for making a computer perform, for an electronic design data of a logic circuit:

a step for generating a test data including the test-code having added a built-in test function; and

a step for automatically generating a logic circuit including a function of the built-in test controller as mentioned above.

Moreover, the present invention provides a test code generation program for making a computer perform, for an electronic design data of a logic circuit:

a step for generating a test data including the test-code having added a unit self-test function; and

a step for automatically generating a logic circuit including a test-code backup register storing the test data including either all of the test-codes or a part of the test-codes.

In addition, the present invention provides an automatic test code generation method in a semiconductor integrated circuit with a built-in test function. The method encompasses adding the built-in test function to the circuit information designed for performing self-test of the circuit under test provided in the semiconductor integrated circuit; and after the step of adding, producing a test code based on the circuit information with addition of the built-in test function and parameters for test-code generation.

### BRIEF DESCRIPTION OF THE DRAWINGS

FIG. 1 is a structural diagram of an LSI and a tester of the first embodiment of the present invention.

FIG. 2 is a circuit diagram showing an example the BIT controller of the first embodiment.

FIG. 3 is a flow chart showing a test method of the first embodiment.

FIG. 4 is a time chart of the first embodiment.

FIG. 5 is a structural diagram of the LSI and the tester of the second embodiment of the present invention.

FIG. 6 is a block diagram showing a structural example of the BIT controller of the second embodiment.

FIG. 7 is a flow chart showing the test method of the second embodiment.

FIG. 8 is a time chart of the second embodiment.

FIG. 9 is a diagram showing the concept of automatic design for test design of the BIT controller shown in FIGS. 1, 2 or FIGS. 5, 6.

FIG. 10 is a flow diagram of the test method of the prior art of the BIT system.

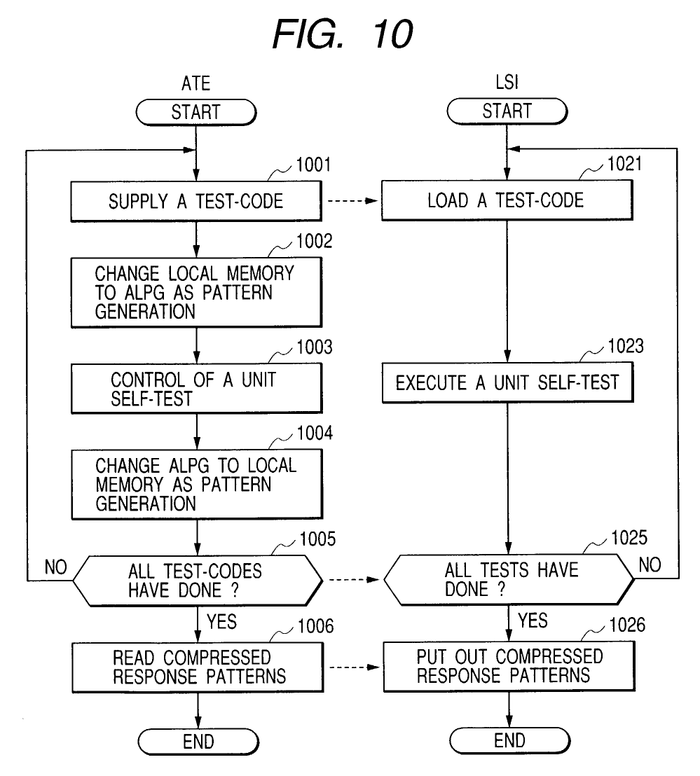

FIG. 11 is a timing chart of the test method of the prior art of the BIT system.

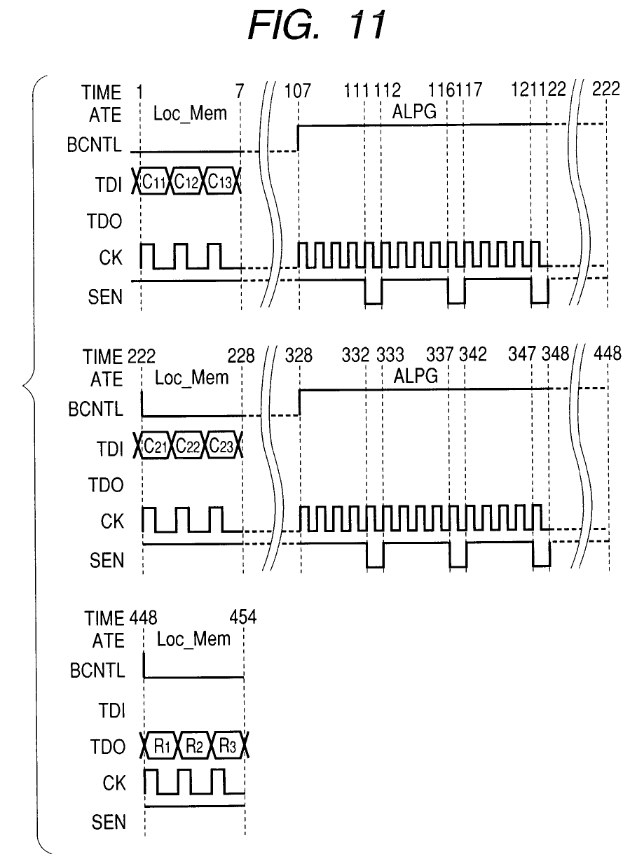

### DETAILED DESCRIPTION OF THE PREFERRED EMBODIMENTS

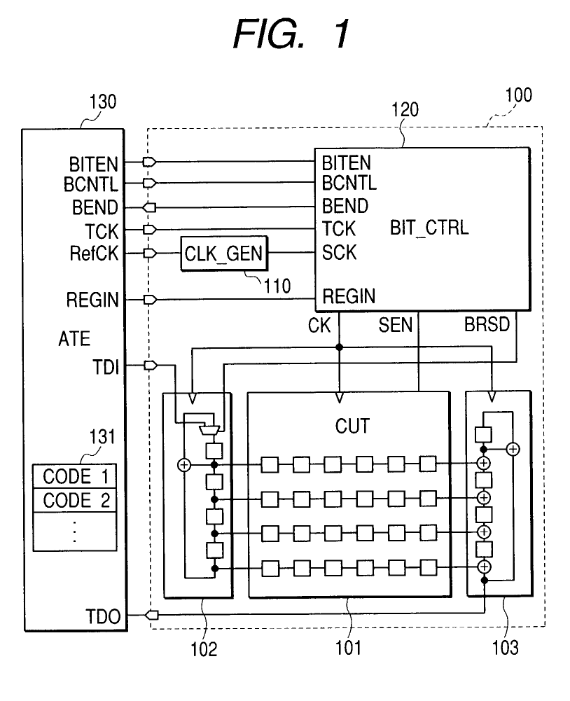

The preferred embodiment of the test method of the present invention will be explained with reference to the accompanying drawings. The like reference numerals designate the like elements throughout the drawings. First, a structure of LSI and a tester in relation to the first embodiment will be explained. FIG. 1 shows an outline of the structure. An LSI 100 is composed of a circuit under test 101, a test pattern generator 102, a test response compactor 103, a clock generator 110 and a BIT controller 120 (built-in test controller or test controller).

As the input signal interface of the LSI 100, a BIT enable signal BITEN, a BIT control signal BCNTL, an external clock signal TCK (or the first clock signal supplied to the LSI from the tester), a reference signal RefCK of the test clock generator 110 and a test data input signal TDI are provided. As the output interface of the LSI 100, a unit self-test end signal BEND indicating the first end of unit self-test during execution of BIT and a test data output signal TD0 for outputting the BIT test result of the LSI 100 are provided.

The circuit under test 101 is formed with the shift-type scan design using a selector. Namely, each scan flip-flop is formed by adding the selector to an edge-trigger type flip-flop synchronized with the clock signal CK supplied to the circuit under test. This scan flip-flop is capable of switching the scan shift operation which is a shift operation through a scan chain consisting of a plurality of scan flip-flops in the circuit under test and the ordinary operation for fetching the data input with a value of the scan enable signal (or scan control signal) SEN. Moreover, in this embodiment, the test method called a test-per-scan is employed.

Namely, in this test method, an output pattern can be measured by setting a logic signal to all scan flip-flops through repetition of the scan-shift operations for the number of times as many as the maximum length of the scan-chain, fetching an output pattern of the combined circuit to each scan flip-flop with once ordinary operation to the preset pattern and repeating again the scan-shift operation for the number of times as many as the maximum length of the scan-chain. The scan design type and test method described here are assumed to simplify the explanation of this embodiment and these are not essential conditions.

The test pattern generator 102 generates a test pattern in synchronization with the clock signal CK supplied to the test under test and generally uses a finite state machine such as the Linear Feedback Shift Register (LFSR). An input signal BRSD switches the internal states of the test pattern generator to the initialization state based on the data from the test data input signal TDI and transition of the internal state. The test response compactor 103 compresses a pattern inputted from the scan-chain in the circuit under test in synchronization with the clock signal CK and generally uses a Multiple Input Signature Register (MISR). The clock generator 110 generates a system clock SCK (or second clock signal) used in the LSI from the reference clock and supplies the signal SCK to the BIT controller 120 and generally uses a phase locked loop (PLL).

The BIT control circuit 120 generates, when the BIT enable signal BITEN is 1, a clock signal CK supplied to the circuit under test, a scan enable signal SEN, a state initializing (reseed) signal BRSD and a unit self-test end signal BEND for the input of the BIT control signal BCNTL, external clock signal TCK and system clock signal SCK. When the BIT enable signal BITEN is 0, the BIT controller 120 generates these signals to assure the ordinary operation of the LSI. Moreover, the BIT control circuit 120 applies, to the circuit under test, the clock signal CK and scan enable signal SEN as the test control signals.

Meanwhile, the tester 130 applies the signals BITEN, BCNTL, TCK and TDI to the input signal interface of the LSI 100 to monitor the signals BEND, TD0 of the output signal interface. A local memory 131 stores the initial state of the test pattern generator 102 and information of the BIT control signals BCNTL, TCK as the test codes for regulating the operations of the unit self-test forming the BIT and these test codes are applied to the LSI 100 through the test data input signal.

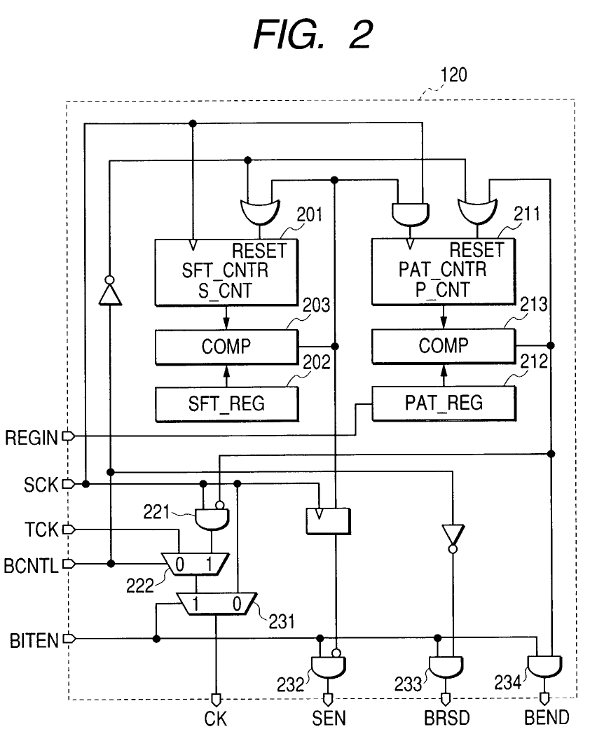

FIG. 2 shows a circuit example of the BIT controller 120 of this embodiment. The BIT controller 120 comprises a shift counter 201 for mainly counting the number of times of the scan-shift operation of the circuit under test, a shift register 202 for storing the maximum length of scan-chain, a comparator 203 for comparing a value of the shift counter 201 with a value of the shift register 202, a pattern counter 211 for counting the number of patterns tested by the circuit under test in the unit self-test, a pattern register 212 for storing the number of patterns tested in the unit self-test, a comparator 213 for comparing the pattern counter 211 with the pattern register 212, a selector 222 for selecting the system clock signal SCK and external clock signal TCK, a circuit 221 for automatically stopping the supply of the clock signal CK supplied to the circuit under test (second clock signal generated based on the external clock signal TCK by the BIT controller) from the system clock signal SCK when the unit self-test ends and moreover a clock selector 231 and fixed-value generators 232, 233, 234 for assuring the ordinary operation of the circuit under test 101 when the BIT enable signal BITEN is 0.

The signals BCNTL, SEN, BRSD, BEND in the BIT controller 120 shown in FIG. 2 have the following meanings. The BIT control signal BCNTL means, when it is 0, the unit self-test state initialization mode and, when it is 1, the unit self-test execution mode. The scan enable signal SEN means, when it is 0, the normal operation mode of the flip-flop of the circuit under test 101 and, when it is 1, the scan-shift operation mode. The state initializing signal BRSD means, when it is 0, the state transition mode of the test pattern generator 102 and, when it is 1, the state initialization mode. The unit self-test end signal BEND means, when it is 0, no-end of the unit self-test execution and, when it is 1, the end of the unit self-test execution.

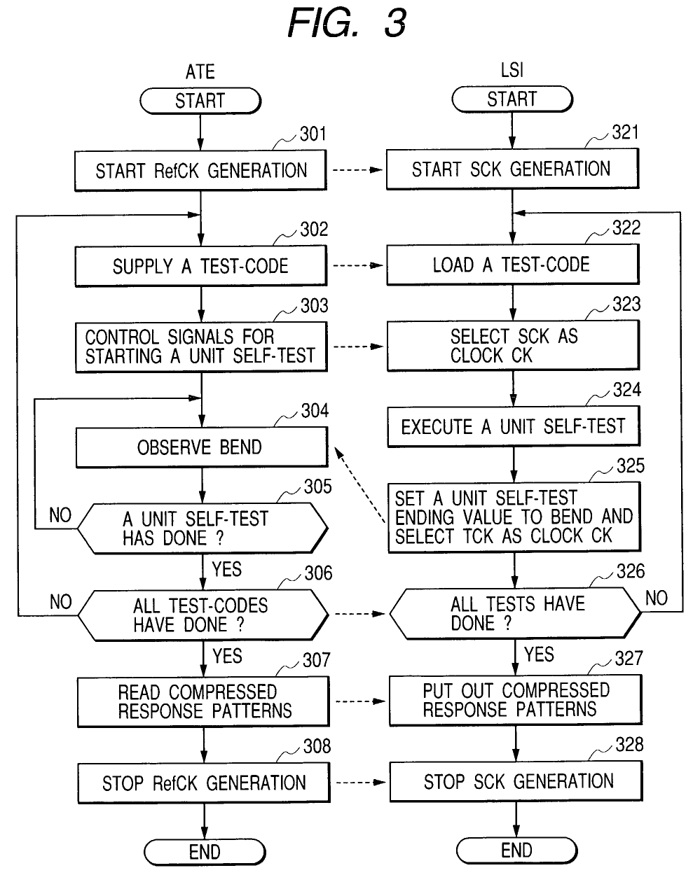

FIG. 3 is a flow diagram of the test method for the BIT system circuit shown in FIG. 1 and FIG. 2. A flow of the tester (ATE) and a flow of the semiconductor integrated circuit (LSI) are illustrated in parallel. First, the ATE 130 starts applying of pulse to the signal RefCK in the step 301 and the LSI starts, in the step 321, generation of the system clock SCK with the clock generator 110 by utilizing such pulse.

The ATE 130 applies, to the LSI, a sequence of the test-code loaded from the local memory in the ATE 130, while the LSI 100 loads in serial such test-code, in the step 322, to the test code register in the test pattern generator 102 in synchronization with the clock signal CK. Upon loading of the test-code, the ATE 130 switches the BIT control signal BCNTL to 1 from 0 in order to control the LSI 100 to start the unit self-test with the clock signal CK from the BIT controller 120 provided within the LSI. At the time of starting the unit self-test, a controller 120 in the LSI 100 switches, in the step 323, the external clock signal TCK to the system clock signal SCK depending on the control signal BCNTL and supplies the clock signal CK to the circuit under test in view of executing the unit self-test in the step 324. The LSI 100 can judge the end of a plurality of unit self-tests from the number of patterns built in the BIT controller 120 and changes the unit self-test end signal BEND to a signal value 1 indicating the end of unit self-test from 0 when the unit self-test ends in the step 325 and then outputs the signal value 1 in order to switch the clock signal CK to be supplied to the circuit under test to the external clock signal TCK from the system clock signal SCK.

During execution of the unit self-test of the LSI, the ATE 130 periodically observes the unit self-test end signals BEND in the steps 304 and 305 and goes to the step 306 upon monitoring the signal 1 indicating the end of unit self-test. The ATE 130 returns to the step 302 when there are test codes not yet loaded in the step 306 and the LSI also returns to the step 322 from the step 326. When the ATE 130 judges that all test codes are loaded in the step 306, it goes to the step 307 and controls the external clock signal TCK to read, onto the local memory in the ATE 130, an output signal indicating the state of the test response compactor 103 for storing, through the compression, a response pattern as the test result from the circuit under test.

In this timing, the LSI 100 outputs a state of the test response compactor in the step 327 depending on such control. Finally, the ATE 130 stops applying of the pulse to the signal RefCK in the step 308, while the LSI 100 stops generation of the system clock SCK using the same pulse in the step 328.

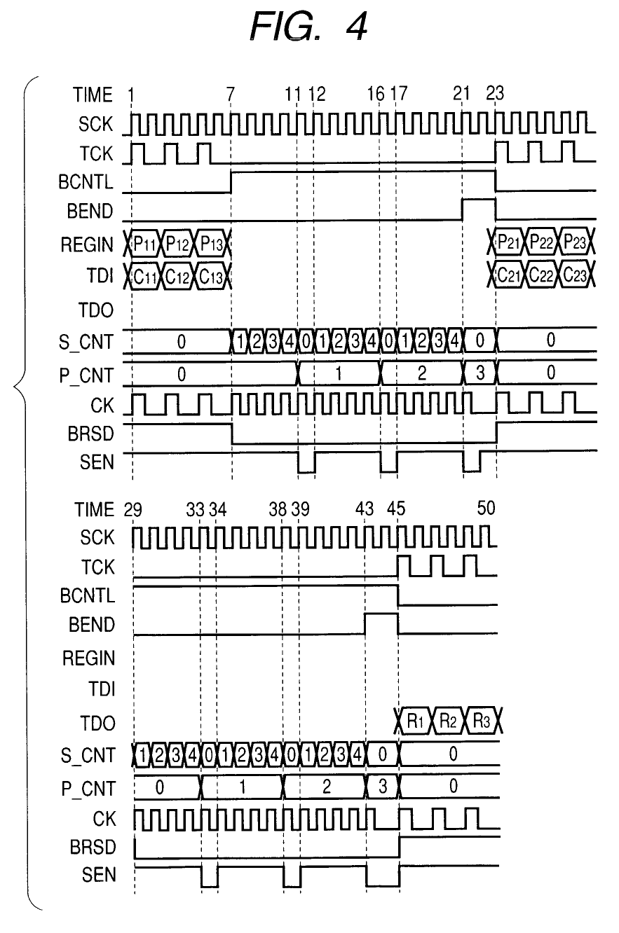

FIG. 4 shows an example of the time chart of this embodiment. In this example, as the pre-condition, the number of registers indicating the states of the test pattern generator 102 and test response compactor 103 is assumed as three (3), the maximum length of the scan-chain is assumed as four (4) and the number of patterns to be tested by the unit self-test is assumed as three (3). Therefore, it is also assumed that the shift register 202 is set to four (4), while the pattern register 212 is set to three (3), respectively. As the state of the test response compactor 103, a certain initial value is assumed to be set before starting the time chart. Moreover, it is also assumed that the free-running system clock SCK is generated in the clock generator 110 and the frequency of the external clock signal TCK is set to a half of the system clock signal SCK.

In FIG. 4, the external clock signal TCK is synchronized with the system clock signal SCK for simplifying the figure. The signals illustrated include an external clock signal TCK as an interface signal of the LSI 100, a BIT control signal BCNTL, a unit self-test end signal BEND, a pattern register input signal REGIN, a test data input signal TDI, a test data output signal TD0, a system clock signal SCK, values of the shift counter S_CNT and pattern counter P_CNT in the BIT controller 120, a clock signal CK supplied to the circuit under test as an output signal of the BIT controller, a state initialization signal BRSD and a scan enable signal SEN.

The period from time 1 to time 6 means the first unit self-test state initialization phase. The tester 130 sets the BIT control signal BCNTL to 0, supplies the external clock signal TCK and also applies the test codes (C11, C12, C13) used for the first unit self-test from the test data input signal TDI. Simultaneously with applying of the signal TDI, the tester 130 applies the patterns (P11, P12, P13) in order to set the number of patterns of the pattern register 212 in the BIT controller 120 using the signal REGIN (FIG. 1, FIG. 2). In the LSI 100, the state initialization signal BRSD is set to 1 and the state initialization value of the test pattern generator is set serially in synchronization with the external clock signal TCK.

The period from time 7 to time 22 means the first unit self-test execution phase. The tester 130 sets the BIT control signal BCNTL to 1 and periodically checks whether the unit self-test end signal BEND is turned to 1 from 0 or not. Within the LSI 100, since the scan enable signal SEN is controlled based on the values of two counters (shift counter and pattern counter), the pattern setting based on the scan-shift operations for four cycles of the system clock SCK and the operation for fetching the test response pattern based on the ordinary operation of the circuit 101 under test for one cycle are repeated for three times. The test response pattern fetched into the scan flip-flop is compressed as the state of the test response compactor 103 during the scan-shift operation corresponding to the next four cycles.

For example, in the period from time 7 to time 10, the first pattern is set and the test for the first pattern, namely the test response pattern of the circuit under test 101 is fetched at the time 11 and the test response pattern is compressed in the period from time 12 to time 15. In the period from time 12 to time 15, the second pattern is also set simultaneously. As explained above, the second pattern is tested at the time 16 and the third pattern is tested at the time 21. The test response pattern for the third pattern is compressed in the four cycles of the clock signal CK to be supplied to the circuit under test after the time 23.

Particularly, at the time 21, a value of the pattern counter P_CNT becomes three (3) which is matched with a value of the pattern register 212. Therefore, the BIT controller 120 judges that the first unit self-test ends and outputs the unit self-test end signal BEND of level 1. Moreover, switching of the operation in which the clock signal CK to be supplied to the circuit under test after the time 22 which has been supplied from the system clock signal SCK is in turn supplied from the external clock signal TCK is automatically conducted with the BIT controller 120.

Upon detection that the unit self-test end signal BEND is in the level 1 at the time 21 to time 22, the tester 130 shifts to the second unit self-test state initialization phase at the time 23 to time 28. In this phase, the tester 130 operates in the same manner as that in the operation explained in regard to the first unit self-test state initialization phase.

Moreover, the period from time 29 to time 44 means the second unit self-test execution phase to test the fourth, fifth and sixth patterns. Detail operations are same as the operations conducted during the period from time 7 to time 22. Only the test codes (C21, C22, C23) are different.

The period from time 45 to time 50 means a test response compactor state read phase. The tester 130 sets the BIT control signal BCNTL to 0, supplies the external clock signal TCK, also reads the test response compactor states (R1, R2, R3) from the test data output signal TD0, then compares it with the expectancy value and judges a test result.

The LSI 100 of this embodiment is characterized in providing a function that supply of clock from the system clock SCK generated by the test clock generator 110 and given to the BIT controller 120 is automatically stopped by the BIT controller 120 when the unit self-test forming the BIT ends and the clock signal (CK) is then supplied to the circuit under test 101 after the system clock SCK is switched to the external clock signal TCK and a function that the unit self-test end signal BEND (or end signal) outputs (or returns) the signal value indicating the end of unit self-test to the tester when the unit self-test ends. The tester 130 periodically observes the unit self-test end signal BEND during execution of the unit self-test and immediately applies the next test code to the LSI 100, upon detection of the signal indicating the end of unit self-test.

With the functions of the LSI 100 explained above and test procedures of the tester, the time required until start of the next unit self-test state initialization after the end of the preceding unit self-test can be saved in the test based on the BIT system consisting of a plurality of unit self-tests. Therefore, this embodiment can provide the effect that the test execution time by the BIT system can be saved.

The first embodiment shown in FIG. 1 to FIG. 4 has been explained above but it is a matter of course that the present invention allows various changes and modifications of embodiments and specifications without departing the contents described in the claims. For example, as the tester 130, an LSI tester is assumed but a part or the entire part of the interface signal applied to the LSI 100 may be generated by a test board connecting the LSI, within the LSI 100 or by the other LSI on the board in which a plurality of LSIs are mounted.

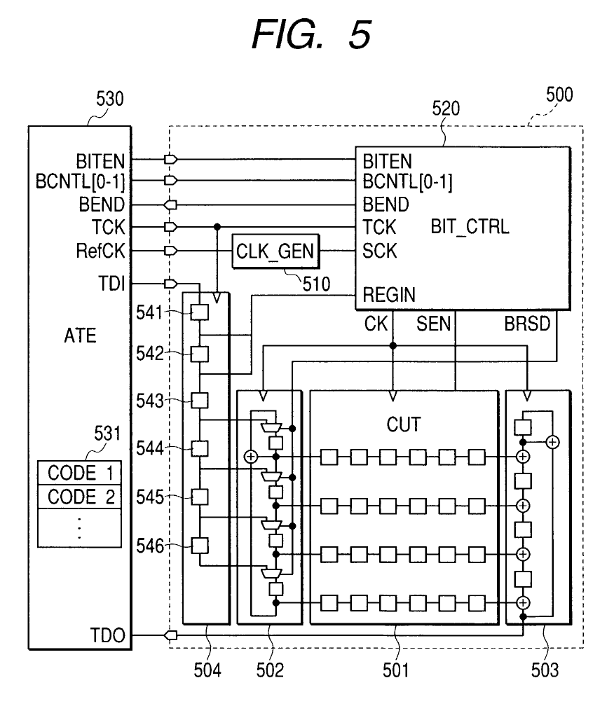

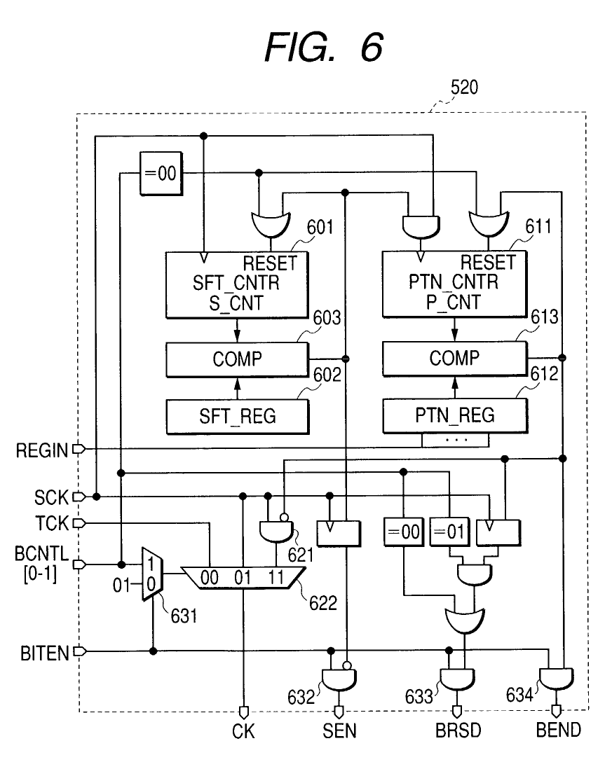

Here, the test board may be provided with a clock generator 110, a BIT controller 120 and a pattern generator 102, with inclusion, moreover, of a clock generator 510, a BIT controller 520 and a pattern generator 502 explained in the second embodiment (FIG. 5, FIG. 6) explained later.

In addition, a part of the test codes stored in the local memory 131 may be stored in a memory provided within the LSI 100 or may be stored in the other memory on the board where a plurality of LSIs are mounted. In addition, this test method can be applied to the test for detecting a fault of the LSI 100 in the manufacturing process and the test for detecting deterioration of the LSI 100 when it is used in the system and is driven to start the operation or it is in the operating condition.

Moreover, in the unit self-test state initialization phase, as the test code, only the state of the test pattern generator 102 has been initialized but it is also possible to initialize the test pattern register 212. It is further possible to attain the merits that the test based on the unwanted pattern in the unit self-test may be saved and the test execution time based on the BIT system can further be reduced by resetting again the number of patterns of the pattern register 212 in order to change the number of patterns to be tested through application of the pattern register input signal REGIN to the BIT controller 120 from the tester (ATE) for each unit self-test.

A structure of LSI in regard to the second embodiment and a tester will be explained below. FIG. 5 is a schematic diagram of such structure. The LSI 500 is composed of a circuit under test 501, a test pattern generator 502, a test response compactor 503, a test-code backup register 504, a clock generator 510 and a BIT controller 520.

As the input signal interface of the LSI 500, a BIT enable signal BITEN, a BIT control signal BCNTL [0-1] (2 bits), an external clock signal TCK (signal supplied from the tester as first clock signal), a reference signal RefCK applied to the clock generator 510 and a test data input signal TDI are provided. As the output signal interface of the LSI 500, a unit self-test end signal BEND indicating the end of the first unit self-test end during execution of the BIT and a test data output signal TD0 for outputting the BIT test result of the LSI 500 are provided.

The circuit under test 501, the test response compactor 503 and clock generator 510 are respectively identical to the circuit under test 101, test response compactor 103 and clock generator 110 of the structures shown in FIG. 1 explained as the first embodiment.

The test pattern generator 502 generates the patterns in synchronization with the clock signal CK supplied to the circuit under test and is identical to the test pattern generator 102 (FIG. 1) in the points that a finite state machine such as LFSR is assumed and the initialization of internal state and transition are switched with the input signal BRSD. However, unlike the test pattern generator 102, the internal state initialization method can be set by parallel copy with the input signal from the test code backup register 504.

The test code backup register 504 is used to previously set the internal state of the test pattern generator 502 and is provided with the test data input signal TDI and the signal applied to the test pattern generator 502. The data from the test data input TDI can be set serially to the register in synchronization with the external clock signal TCK.

The BIT controller 520 (or test controller) generates, when the BIT enable signal BITEN is 1, the clock signal CK supplied to the circuit under test, scan enable signal SEN, state initialization signal BRSD and unit self-test end signal BEND for the input of the BIT control signal BCNTL [0-1], external clock signal TCK and system clock signal SCK (the signal generated by the clock generator 510 and is supplied to the controller 520 as the third clock signal). Moreover, the supply clock signal CK is generated by the controller 520 and is then supplied to the circuit under test as the second clock signal.

When the BIT enable signal BITEN is 0, above signals are generated to assure the ordinary operations of the LSI. In comparison with the BIT controller 120 (FIG. 1), only the BIT control signal BCNTL becomes 2 bits in regard to the input/output interfaces but control of the other signals is different.

On the other hand, the tester 530 observes the output signal interface signals by applying a signal to the input signal interface of the LSI 500. Like the first embodiment, the initial state information of the test pattern generator 502 applied using the test data input signal TDI, BIT control signal BCNTL [0-1] and information about TCK are stored to the local memory 531 as the test-codes required for execution of the unit self-test forming the BIT.

FIG. 6 shows an example of the BIT controller 520 of this embodiment. The BIT controller 520 mainly comprises a shift counter 601 for counting the number of times of scan-shift operation, a shift register 602 for storing the maximum length of the scan-chain, a comparator 603 for comparing a value of the shift counter 601 with a value of the shift register 602, a pattern counter 611 for counting the number of patterns to be tested by the unit self-test, a pattern register 612 for storing the number of patterns to be tested by the unit self-test, a comparator 613 for comparing the pattern counter 611 and the pattern register 612, a selector 622 for selecting the system clock signal SCK and the external clock signal TCK, a circuit 621 for automatically stopping the supply of the clock signal to the clock signal CK supplied to the circuit under test from the system clock signal SCK when the unit self-test ends and a clock selector 631 and fixed-value generators 632, 633, 634 for assuring the ordinary operation of the circuit 501 under test when the BIT enable signal BITEN is 0.

The signals SEN, BEND of the BIT controller 520 shown in FIG. 6 have the same meanings as that of the BIT controller 120 of FIG. 2. Namely, the control signal BCNTL[0-1] means, when it is 00, the unit self-test state initialization mode, or, when it is 01, the unit self-test mode without automatic stop or, when it is 11, the unit self-test mode with automatic stop. The state initialization signal BRSD means, when it is 0, that the test pattern generator 502 is in the state transition mode, or, when it is 1, the test pattern generator 502 is in the state initialization mode and a value of the test code backup register 504 is copied in parallel to the state of the test pattern generator 502.

The pattern register input signal REGIN is applied to the BIT controller 520 via the test code backup register 504 from the tester 530 (ATE) for every unit self-test. As explained above in regard to the first embodiment, it is possible to attain the merits that test based on the unwanted test patterns in the unit self-test can be eliminated and the text execution time based on the BIT system can further be saved by setting again the number of patterns of the pattern register 612 through application of the relevant input signal REGIN and then( enabling the change of the number of patterns to be tested.

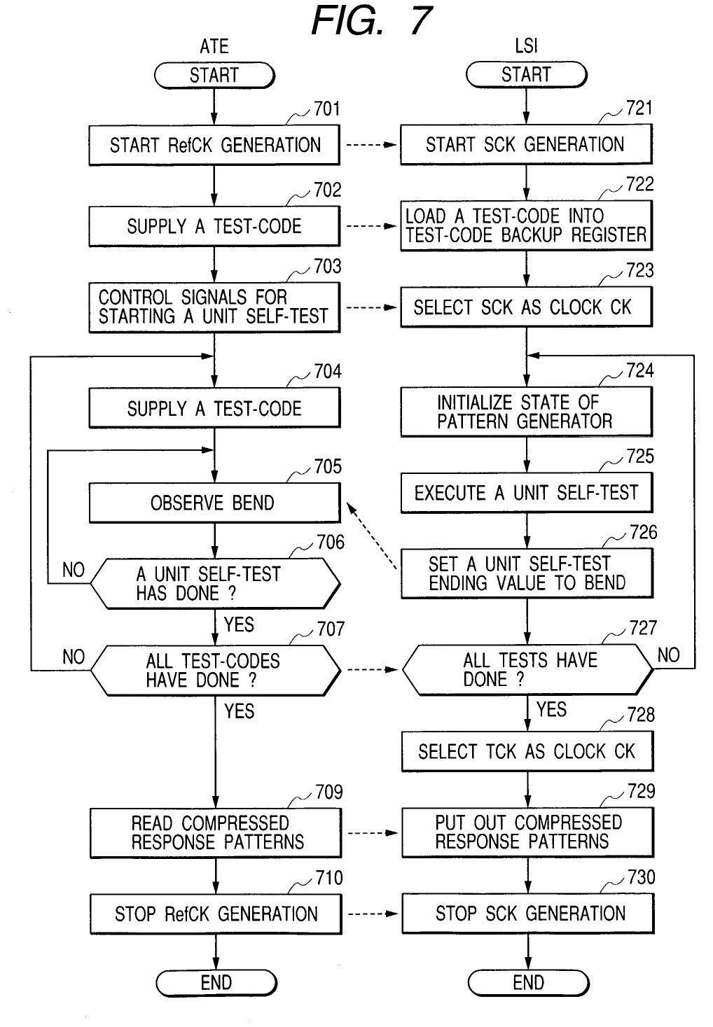

FIG. 7 shows a flow chart of the test method for the circuit of the BIT system shown in FIG. 5 and FIG. 6. A flow of the tester 530 (ATE) and a flow of the semiconductor integrated circuit 500 (LSI) are illustrated in parallel. First, the ATE 530 starts applying of pulse to the signal RefCK in the step 701, while the LSI 500 starts, in the step 721, generation of the system clock SCK with the clock generator 510 using such pulse.

The ATE 530 applies, in the step 702, a sequence of the test-code loaded from the local memory in the ATE 530 to the LSI and the LSI 500 serially loads, in the step 722, the test-code to the test code backup register 504 in synchronization with the external clock TCK.

Upon loading of the test-code, the ATE 530 switches, in the step 703, the BIT control signal BCNTL to the unit self-test mode “11” with automatic stop from the unit self-test state initialization mode “00” and controls the LSI 500 to start the unit self-test with the clock signal CK supplied to the circuit under test from the BIT control circuit 520.

The LSI 500 supplies, to the circuit under test, in the step 723, the clock signal CK by switching the external clock signal TCK to the system clock signal SCK and copies in parallel, in the step 724, the data in the test-code backup register when the unit self-test is started, to the test-code register in the test pattern generator 502. The LSI 500 executes in the step 725 the unit self-test and outputs, when the unit self-test ends in the step 726, the unit self-test end signal BEND after it is changed to the signal value 1 indicating the end of unit self-test from 0.

The ATE 530 serially loads, in the step 704, the test-code for the next unit self-test, during the unit self-test of the LSI 500, to the test-code backup register 504 in synchronization with the external clock TCK. Upon the loading of the next test-code, the ATE 530 periodically observes the unit self-test end signal BEND in the steps 705, 706 and goes to the step 707 after it has monitored the signal value 1 indicating the end of unit self-test.

The ATE 530 returns to the step 704 when there is the test-code which is not yet loaded in the step 707 and newly sets the next test-code for the unit self-test to the test-code backup register by loading it thereto. The LSI also returns to the step 724 from the step 727.

When the ATE 530 has judged that all test-codes are loaded in the step 707, it goes to the step 709 and controls to read, onto the local memory therein, an output signal indicating the state of the test response compactor 503 which stores, through compression, the test response pattern as a result of test from the circuit under test by supplying the external clock signal TCK thereto.

In this case, the LSI 500 switches, depending on such control, the clock signal CK supplied to the circuit under test to the external clock signal TCK from the system clock signal SCK in the step 728 and outputs the state of the test response compactor in the step 729.

Finally, the ATE 530 stops applying of pulse to the signal RefCK in the step 710 and the LSI stops generation of the system clock SCK using such pulse in the step 730.

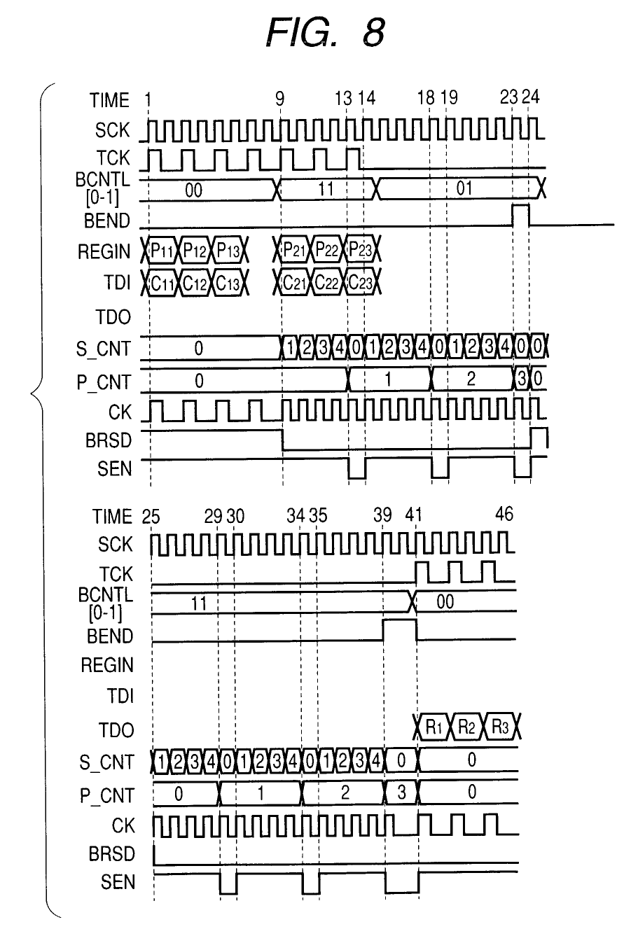

FIG. 8 shows an example of the time chart of the present embodiment. This example is based on the pre-condition explained in regard to the time chart of FIG. 4. Moreover, the signals illustrated are identical to those illustrated in the time chart of FIG. 4. The period from time 1 to time 8 means the first unit self-test state initialization phase. The tester 530 sets the BIT control signal BCNTL [0-1] to 00 and supplies the external clock TCK and also applies the test-code (C11, C12, C13) to be used for the first unit self-test from the test-data input signal TDI. The tester 530 applies the pattern (P11, P12, P13), simultaneously with applying of the signal TDI, in order to set the number of patterns of the pattern register 612 in the BIT controller 520 using the signal REGIN (FIG. 5, FIG. 6).

In the LSI 500, the test-code is set in serial to the test-code backup register 504 in synchronization with the external clock signal TCK. Since the state initialization signal BRSD is set to 1 in parallel with this setting, the internal state of the test pattern generator 502 is set in synchronization with the external clock signal TCK by copying in parallel the value of the test-code backup register 504. At the time 7, setting of the test-code (C11, C12, C13) to the test pattern generator 502 is completed.

The period from time 9 to time 24 means the first unit self-test execution phase. At the time 9, the tester 530 starts the unit self-test execution of the LSI 500 by setting the BIT control signal BCNTL [0-1] to 11. In parallel with this operation, the tester 530 supplies the external clock signal TCK in the period from time 9 to time 14 and also applies the test-code (C21, C22, C23) to be used for the second unit self-test from the test-data input signal TDI. The tester 530 applies, simultaneously with applying of the signal TDI, the pattern (P21, P22, P23) using the signal REGIN (FIG. 5, FIG. 6) to set the number of patterns of the pattern register 612 in the BIT controller 520.

The LSI 500 sets the test-code to the test-code backup register 504. In this timing, when the unit self-test execution is completed while the first unit self-test execution is being continued and if the BIT control signal BCNTL [0-1] is set to 11, supply of clock signal CK to the circuit under test from the system clock signal SCK is automatically stopped.

In the period from time 15 to time 23, the tester 530 sets the BIT control signal BCNTL [0-1] to 01 and periodically checks whether the unit self-test end signal BEND is changed to 1 from 0 or not. In this case, the LSI 500 immediately copies, upon completion of the first unit self-test execution, a value of the test-code backup register 504 to the internal state of the test pattern generator 502 to complete the preparation for start of the second unit self-test. The unit self-test in the period from time 9 to time 23 is executed, corresponding to the time 7 to time 21 in the time chart of the first embodiment, as repetition of the scan-shift operation of four cycles and ordinary operation of one cycle in order to test the first, second and third patterns.

Particularly, at the time 23, the pattern counter P_CNT 611 becomes 3 which is matched with a value of the pattern register 612. Therefore, the BIT controller 520 judges that the first unit self-test is completed and outputs the level 1 to the unit self-test end signal BEND. Moreover, at the time 24, the preparation for the second unit self-test execution is completed by copying in parallel the second test-code set to the test-code backup register 504 to the pattern generator 502 and then resetting the counter.

The tester 530 sets, upon observing at the time 23 that the unit self-test end signal BEND is 1, the BIT control signal BCNTL [0-1] to 11 at the time 25 and starts the second unit self-test execution. The period from time 25 to time 41 means the second unit self-test execution phase. In this phase, the operations identical to those in the period from time 29 to time 44 in the first embodiment are conducted.

In the embodiment and time chart explained here, since the second unit self-test is the final execution, it is not required to set the test-code used for the third unit self-test, but when such second unit self-test is not the final execution, the setting of the test-code backup register 504 is required in parallel with the unit self-test execution in the period from time 9 to time 14. The period from time 41 to time 46 means the test response compactor state read phase and the operations conducted in this period is identical to that in the period from time 45 to time 50 in the first embodiment shown in FIG. 4.

The LSI 500 of this embodiment is characterized in providing a function that setting of the test-code required for execution of the unit self-test can be made in parallel during execution of the last unit self-test and a function that the next unit self-test may be started immediately after the end of the first unit self-test execution. The tester 530 periodically observes the self-test end signal BEND during execution of the unit self-test and immediately applies the next test-code to the LSI 500 when it observes the end of the unit self-test.

With the functions of the LSI 500 and test procedures of the tester 530, the time required for setting of the test-code of the unit self-test can be reduced to almost zero in the test based on the BIT system composed of a plurality of unit self-tests. Therefore, this embodiment can reduce the time required for execution of the tests based on the BIT system.

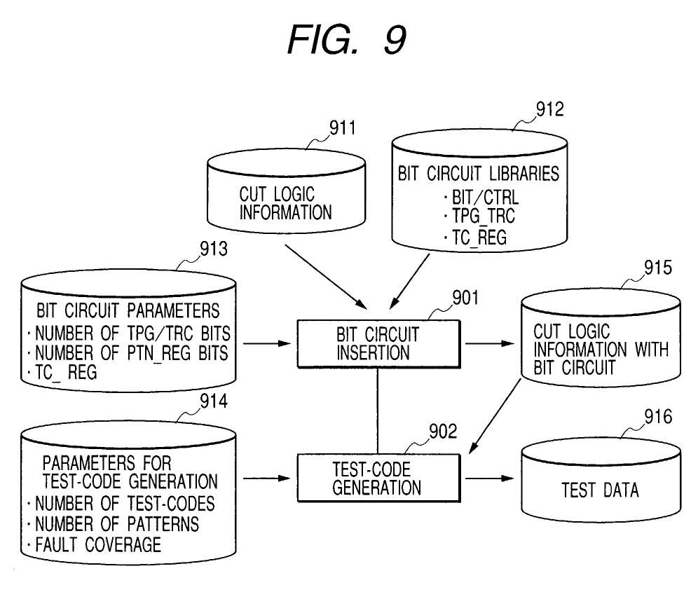

FIG. 9 is a diagram showing the concept of DA (Design Automation) for designing a circuit of the BIT system shown in FIG. 1, FIG. 2 or in FIG. 5, FIG. 6. The processes can be sorted mainly to the BIT circuit insertion in the step 901 and generation of test-code in the step 902. In the step 901, the function of the BIT system is inserted to the circuit information given in the design-for-test and in the step 902, a test pattern is generated for the circuit under test assuming a fault model such as stuck-at-fault or the like and this test pattern is then converted to a test-code.

First, an input in the step 901 includes a logic information of the circuit under test 911, a BIT circuit library 912 and a BIT circuit parameter 913. The logic information of the circuit under test 911 assumes an addition of the scan circuit to the circuit used for ordinary data input operation and is expressed as an electronic information such as a net list or the like.

The BIT circuit library 912 is composed of circuit logic information pieces of the BIT controller 120, 520, test pattern generator 102, 502, test response compactor 103, 503 and test-code backup register 504 and the number of bits of the data pattern read or generated in each circuit is expressed as an electronic information such as net list of the variable format.

The BIT circuit parameter 913 is the parameter indicating the number of bits of the data pattern read or generated in the test pattern generator 102, 502, test response compactor 103, 503, indicating the number of bits of the data pattern read into the pattern register 212, 612 and indicating existence or no-existence of the test-code backup register and is expressed with an electronic information.

In the step 901, the logic information 915 of circuit under test of the BIT circuit insertion, which is obtained by adding the BIT system function to the logic information of circuit under test 911 while the ordinary data input operation is maintained, is generated based on the input information of the circuit library 912 and circuit parameter 913 to be inputted to the logic information of circuit under test 911 and this logic information 915 generated is then outputted as an electronic information such as a net list or the like.

In other words, the logic information of circuit under test in which a scan circuit is added to the circuit used for the ordinary data input operation, the circuit library expressed as an electronic information and the circuit parameter are inputted, the logic information of circuit under test with insertion of a built-in circuit having added the built-in test function while maintaining the ordinary data input operation to the logic information of circuit under test is generated and this generated logic information is then outputted as an electronic information.

Next, the input in the step 902 includes a logic information 915 of circuit under test of BIT circuit insertion and a parameters for test-code generation 914. The parameters for test-code generation 914 is the electronic information including the number of test-codes, number of patterns and the target fault coverage, etc. In the step 902, a test data 916 including the test-code is generated based on the input information of the logic information 915 explained above and the parameters for test-code generation 914 and this generated test data 916 is then outputted as the electronic information of waveform or the like. The tester supplies the relevant test data 916 to a semiconductor integrated circuit.

In the design automation process explained above, the BIT library 912 used, logic information of circuit under test 911, BIT circuit parameter 913, logic information 915 of circuit under test of BIT circuit insertion, parameters for test-code generation 914 are stored in a file or the like as a storage medium in the testers 130, 530 of the first and second embodiments explained above as the electronic information. Moreover, a program for executing the design automation process and generating a test data 916 including the test-code is also stored in the storage medium.

Moreover, in view of embodying the present invention, a storage medium which is characterized in the items (i) and (ii) explained below is also provided to store the electronic design data (or IP data) consisting of the program explained above and to use such data as the design resource of LSI.

(i) The storage medium is characterized in storing an electronic design data comprising a test-code generation program for making a computer perform, for an electronic design data of a logic circuit:

a step for generating a test data including the test-code having added a built-in test function; and

a step for automatically generating a logic circuit including a function of the built-in test controller as mentioned above.

(ii) The storage medium is characterized in storing an electronic design data comprising a test-code generation program for making a computer perform, for an electronic design data of a logic circuit:

a step for generating a test data including the test-code having added a unit self-test function; and

a step for automatically generating a logic circuit including a test-code backup register as mentioned above.

The present invention can provide the effect that the test execution time can be shortened because the time required for loading the test-code stored in the external circuit can be reduced by providing a semiconductor integrated circuit with a built-in test function and a storage medium for storing an electronic design data consisting of a test code generation program and also utilizing a test method of semiconductor integrated circuit, an automatic test-code generation method and a program thereof.

What is claimed is:

1. A semiconductor integrated circuit with built-in test function comprising:
a test-code register for storing test-codes of a plurality of unit self-tests of which operations are regulated with a test-code given from an external circuit;
a first clock signal used for setting said test-code to said test-code register;
a second clock signal used for operations of said unit self-tests;
an end signal indicating whether a unit self-test is completed or not; and
a built-in test controller for inputting said first and second clock signals to generate a signal required for control of the circuit under test and said end signal,
wherein said built-in test controller automatically stops, when the unit self-test is completed, that said second clock signal is supplied to the circuit under test, and sets, when the unit self-test is completed, a signal value indicating the end of unit self-test to said end signal.

2. A semiconductor integrated circuit with built-in test function according to claim 1, wherein said semiconductor integrated circuit includes a test clock generator and a test pattern generator, said test-code is read from a memory provided within a tester externally provided and is then supplied to said semiconductor integrated circuit, said test-code register is provided within said test pattern generator, said first clock signal is an external clock signal supplied to said semiconductor integrated circuit from said tester, said second clock signal is a system clock signal generated by said test clock generator provided in said semiconductor integrated circuit and said end signal is a unit self-test end signal for returning a signal indicating the end of unit self-test to said tester when said semiconductor integrated circuit completes said unit self-test.

3. A semiconductor integrated circuit with built-in test function according to claim 1, wherein said built-in test controller includes a counter for counting the number of times of scan-shift operation of the circuit under test and a counter for counting the number of patterns for testing said circuit under test.

4. A semiconductor integrated circuit with built-in test function according to claim 3, wherein said scan-shift operation is a shift operation conducted through a scan-chain comprising a plurality of flip-flops as the scan flip-flops within said circuit under test.

8. A semiconductor integrated circuit test method for including a plurality of menus of unit self-tests of which operation is regulated with a test-code given from an external circuit of said semiconductor integrated circuit, the method comprising:
a first step for setting a test-code to a test-code register provided within a test pattern generator, by using a first clock signal supplied from a tester;
a second step for performing one of said unit self-tests of the circuit under test by using a second clock signal generated in said semiconductor integrated circuit;
a third step for performing a monitoring of a unit self-test end signal indicating the end of the predetermined unit self-test by said tester; and
a fourth step for returning to said first step until the menu of a plurality of said unit self-tests ends.

9. A semiconductor integrated circuit test method according to claim 8, wherein in said first step, said tester applies a sequence of said test-code read from a memory provided in said tester to said semiconductor integrated circuit and a test controller provided in said semiconductor integrated circuit loads said test-code to said test-code register in synchronism with said second clock signal generated based on said first clock signal.

10. A semiconductor integrated circuit test method according to claim 8, wherein in said second step, said tester switches a control signal to the unit self-test execution mode to execute the unit self-test by enabling said semiconductor integrated circuit to start the unit self-test with using said second clock signal from the test controller provided in said semiconductor integrated circuit.

11. A semiconductor integrated circuit test method according to claim 8, wherein the end of said plurality of said unit self-tests is determined by a pattern counter built in a test controller provided within said semiconductor integrated circuit.

12. A semiconductor integrated circuit test method according to claim 8, wherein in said fourth step, said tester returns to said first step when there are test-codes which are not yet loaded, and controls said first clock signal when said tester has determined that all test-codes are loaded, so as to read onto the memory in said tester an output signal indicating a state of a test response compactor for storing, through the compression, a response pattern as a result of test from said circuit under test.

13. A semiconductor integrated circuit test method according to claim 8, wherein said first clock signal is an external clock signal supplied to said semiconductor integrated circuit from said tester and said second clock signal is a supply clock signal which is generated in a test controller and is supplied to said circuit under test.

14. A semiconductor integrated circuit test method according to claim 10, wherein said semiconductor integrated circuit further includes a test clock generator, and in said second step, said semiconductor integrated circuit supplies, at the time of starting said unit self-test, said second clock signal to said circuit under test by switching from said first clock signal to a third clock signal depending on said control signal given from said tester, and said third clock signal is a system clock signal given to said test controller from said test clock generator.

15. A semiconductor integrated circuit test method according to claim 11, wherein said semiconductor integrated circuit further includes a test clock generator, and said test controller outputs, when said unit self-test ends, said unit self-test end signal and switches said second clock signal to said first clock signal from a third clock signal, said tester periodically observes said unit self-test end signal during the execution of said unit self-test in said semiconductor integrated circuit and said third clock signal is a system clock signal given to the test controller from the test clock generator.

27. A test-code generation program for making a computer perform, for an electronic design data of a logic circuit:
a step for generating a test data including the test-code having added a built-in test function; and
a step for automatically generating a logic circuit including a function of the built-in test controller according to claim 1.

28. A test code generation program for making a computer perform, for an electronic design data of a logic circuit:
a step for generating a test data including the test-code having added a unit self-test function; and
a step for automatically generating a logic circuit including a test-code backup register storing the test data including either all of the test-codes or a part of the test-codes.

29. A storage medium for storing an electronic design data comprising a test-code generation program for making a computer perform, for an electronic design data of a logic circuit:
a step for generating a test data including the test-code having added a built-in test function; and
a step for automatically generating a logic circuit including a function of the built-in test controller according to claim 1.

30. A storage medium for storing an electronic design data comprising a test-code generation program for making a computer perform, for an electronic design data of a logic circuit:
a step for generating a test data including the test-code having added a unit self-test function; and
a step for automatically generating a logic circuit including a test-code backup register storing the test data including either all of the test-codes or a part of the test-codes.

31. An automatic test code generation method in a semiconductor integrated circuit with a built-in test function, comprising the steps of;
adding the built-in test function to the circuit information designed for performing self-test of the circuit under test provided in said semiconductor integrated circuit; and
after said step of adding, producing a test code based on the circuit information with addition of the built-in test function and parameters for test-code generation.

32. An automatic test code generation method according to claim 31, wherein said step of adding further includes a step of inputting a logic information of circuit under test with the addition of a scan circuit to the circuit used for the normal data input operation, a circuit library represented as an electronic information and a circuit parameter; generating a logic information of circuit under test with a built-in circuit having added said built-in test function while maintaining a function of the normal data input operation to said logic information of circuit under test; and outputting said logic information as an electronic information.

33. An automatic test code generation method according to claim 31, wherein said step of producing further includes a step of inputting a logic information of circuit under test with a built-in circuit as a circuit information having added said built-in test function and said parameters for test-code generation; and outputting said test data as an electronic information.

34. An automatic test code generation method according to claim 32, wherein said circuit library is a library for storing a built-in test controller, a test pattern generator, a test response compactor and a test code backup register as an electronic information and said circuit parameter is a parameter for representing as an electronic information, the number of bits of data pattern read or generated in said test pattern generator and said test response compactor, the number of bits of data read onto the pattern register built in said built-in test controller and an existence or no-existence of said test code backup register.
